(19) United States
(12) Patent Application Publication
(10) Pub. No.: US 2007/0276717 A1
(43) Pub. Date: Nov. 29, 2007

(54) Headcount estimating system, method and tool

(76) Inventors: Aaron D. Alburey, Loughborough (GB); Richard Coombes, Surrey (GB); Peter Farrar, Ponte Vedra Beach, FL (US); Jon Green, Vancouver (CA); Jeffrey C. Hamilton, Menlo Park, CA (US); Steven W. Hendryx, Dillon, CO (US); Cameron C. McKelvey, Houston, TX (US); Christopher McManus, Atlanta, GA (US)

Correspondence Address: ACCENTURE CHICAGO 28164;BRINKS HOFER GILSON & LIONE, P O BOX 10395, CHICAGO, IL, 60610, US

(21) Appl. No.: 11/442,644

(22) Filed: May 26, 2006

(51) Int. Cl. G06F 9/46

(52) U.S. Cl. 705/8

(57) ABSTRACT

A method, system and tool are disclosed for estimating headcounts. An input and selected metric are received. The metric is selected based on a span of control. A full-time equivalent is calculated in accordance with the input and the selected metric.

### TECHNICAL FIELD

Generally a tool is disclosed for estimating headcounts, and more particularly headcount for a human resource service delivery model that includes business partners, centers of expertise, and human resource shared services.

### BACKGROUND

Human Resource executives may play a major role in helping their organizations achieve high performance. A component of this effort may be to optimize human resource service delivery. When human resource services are delivered efficiently, human resource executives may be relieved of traditional administrative burdens. They can focus on aligning human capital strategy with business strategy to improve productivity and create competitive differentiation. Improving human resource service delivery may be achieved by implementing large scale solutions, such as new human resource technologies, redesigned human resource processes, and organizational changes. These solutions may result in the need to reevaluate and adjust the human resource headcount that supports the new human resource service delivery structure.

### BRIEF SUMMARY

A method, system and tool are disclosed for estimating headcounts. An input and selected metric are received. The metric is selected based on a span of control. A full-time equivalent is calculated in accordance with the input and the selected metric.

Other systems, methods, tools, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a block diagram illustrating a tool for estimating full-time equivalents of needed resources.

FIG. 2 is a block diagram illustrating general human resource groups.

FIG. 3 is a flowchart showing a use of the tool.

FIG. 4 is a screenshot of an exemplary input screen worksheet of the tool.

FIG. 5 is a screenshot of an exemplary business partner headcount worksheet of the tool.

FIG. 6 is a screenshot of a exemplary centers of expertise worksheet.

FIG. 7 is a screenshot of centers of expertise headcount estimate with the pop-up choices for default values for estimating a headcount of full-time employees.

FIG. 8 is a screenshot of a worksheet for exemplary human resource shared service center inputs.

FIG. 9 is a screenshot of outputs for the human resource shared service center headcount estimates.

FIG. 10 is a screenshot of a summary worksheet.

FIG. 11 is a block diagram illustrating a general computer system of the tool.

### DETAILED DESCRIPTION

A system, method and tool, hereinafter referred to generally as a tool, is disclosed that may be used to estimate a full-time equivalent (FTE) of resources needed for business or private entities. The tool will be described in terms of estimating a number of full-time equivalent personnel needed to manage a business, also referred to as a company or client. The full-time equivalent may include all active employees currently on the payroll. Part-time employees may be converted to full-time equivalents and contractors may be excluded from these numbers. The estimates may be used to help determine a headcount of personnel needed for various human resource departments.

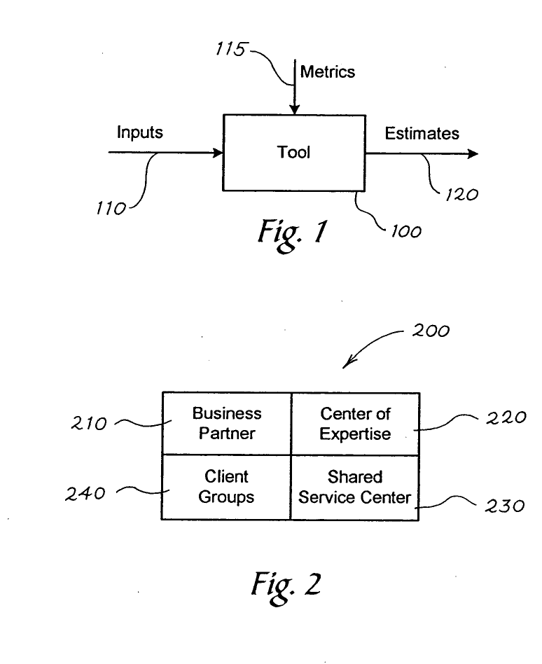

FIG. 1 is a block diagram illustrating a tool 100 for estimating a full-time equivalent of needed resources. One full-time equivalent may equal one employee employed full-time with the business. Part-time employees may be converted to full-time equivalents. Contractors may be excluded from the number of full-time equivalents. The tool 100 may be implemented with hardware, firmware and/or software, such as MICROSOFT EXCEL. The tool 100 uses inputted information 110 and metrics 115 to provide outputted estimates 120, such as estimating personnel needed for a human resource department of a business. The inputted information 110, which may be collected as part of a business case development process, may include a number of employees, a number of business units, a number of regions in which the company operates, a number of outsourced recruiting vendors, a number of outsourced health and welfare vendors, a number of vacancies, a number of planned centers of expertise and whether the centers of expertise are insourced and/or outsourced. The estimates 120 may be used to direct a user towards estimated human resource headcount. The estimates 120 may cover insourcing, e.g., when the human resource functions are handled by personnel within the business, and/or outsourcing, e.g., when the human resource functions are handled by sources outside of the business. The estimates 120 may be refined based on clients' specific business requirements and/or target solutions. The tool 100 may be used internally, by a consultant and/or by clients, to help speed up a determination of the human resource full-time equivalents. Additional time may be used to analyze the results and refine the estimates 120.

FIG. 2 is a block diagram illustrating general human resource groups 200. The human resource groups 200 may include business partner 210, centers of expertise 220, shared service center 230 and client groups 240. The business partner 210 may translate business unit needs into human resource requirements and evaluate human resource services delivered to their business units. The business unit may correlate to the structure in which a company organizes and operates its business. Common client terms include business unit, business segment or division. The highest level of business unit may include its own profit and loss statement. The centers of expertise 220 may design and build the human resource programs that meet the business units' human resource requirements. The shared service center 230 may deliver transactional and high volume human resource services to client groups 240. The client groups 240 may receive human resource services and use self-service functionality and tools. The human resource groups 200 may be used together to help ensure that the proper work is accomplished by the correct resources at an appropriate cost by translating business needs to solutions.

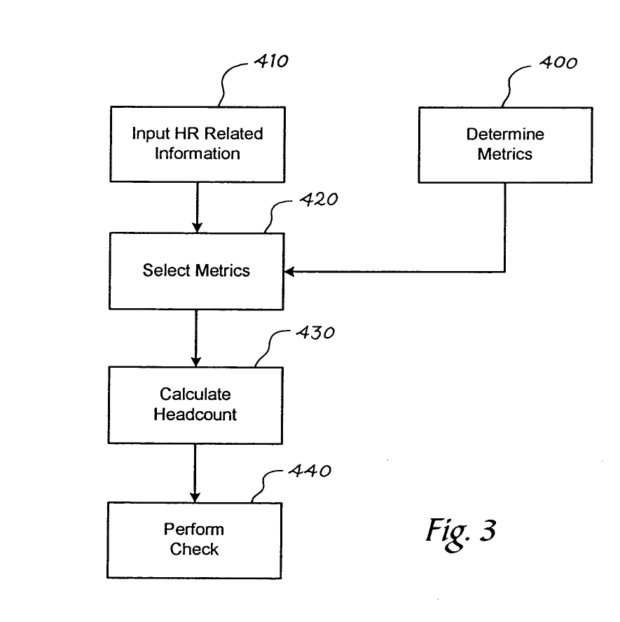

FIG. 3 is a flowchart showing a use of the tool 100. At block 400, metrics are determined. The metrics may be based on experience and balanced by benchmarks. The metrics may be determined before the tool 100 is used and may be updated periodically. The metrics are values that are used by the tool 100 during calculation of the full-time equivalents. The values of the metrics may vary depending on the human resource roles, e.g., business partner, center of expertise, and shared service center, and the human resource functions, e.g., recruiting, compensation and benefits.

At block 410, human resource related information may be inputted into the tool 100. At block 420, the metric may be inputted, such as in accordance with a user selectable option, as described in more detail below. The metric options may be ranked, such as high, medium and low, which may be referred to as a span of control. The rankings include descriptions that aid the user in determining which option to choose, e.g., high, medium or low. When the tool 100 is used for a small company, e.g. less than six thousand employees, the low value for span of control may be selected for all of the spans of control. Moreover, for headcounts involving low-technology companies, the low value may be selected most of the time.

At block 430, the full-time equivalent may be calculated in accordance with the inputted information and the selected metric. The business partner headcount may be calculated for each business unit. The centers of expertise headcount may be calculated for each human resource function typically included in a center of expertise, e.g., recruitment, organization effectiveness, performance management, compensation and benefits, training and development, employee relations, and staffing. The human resource (HR) shared services headcount may be calculated for each HR function typically included in a HR shared service center, e.g., recruitment, staffing, employee relations, training & development, performance management, compensation & benefits, payroll, time & attendance, termination, HR reporting, and HR information systems,

At block 440, an overall check may be performed, such as based on a comparison of the calculated results with one or more overall check metric values. After calculating total human resource FTEs and ratio of human resource FTEs to employees, the tool may provide an overall comparison to an external benchmark value. One source for external benchmark values is SARATOGA, a PricewaterhouseCoopers offering. SARATOGA offers Human Capital measurement, benchmarking and strategic application of Human Capital information.

By way of example, the following is a description of an exemplary tool 100 used for estimating headcounts for human resources. Screen shots of the tool 100 implemented with MICROSOFT EXCEL show one way of implementing the tool 100.

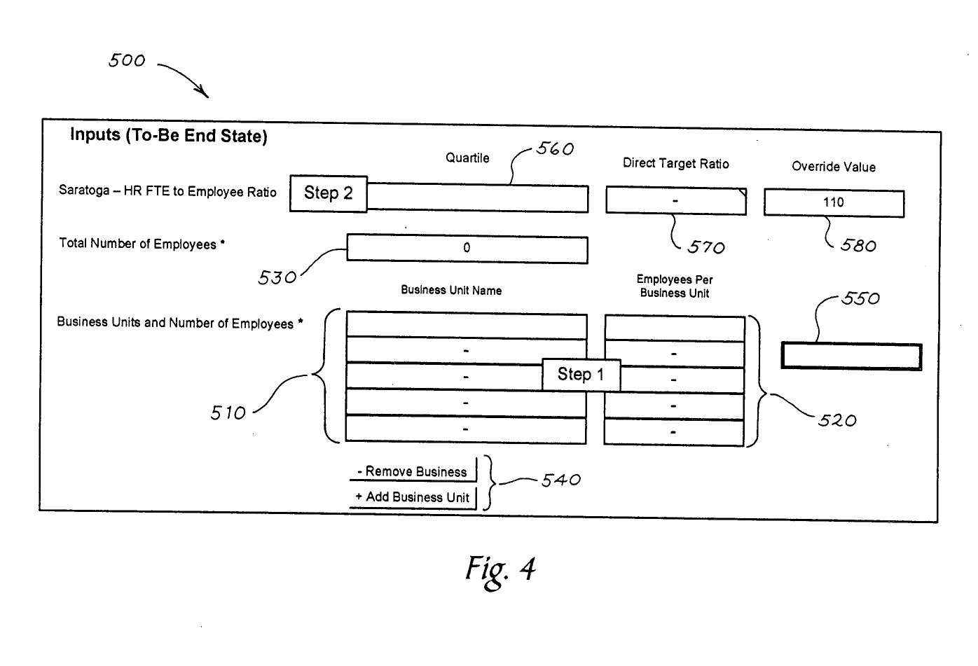

FIG. 4 is a screenshot of an exemplary input screen worksheet 500 of the tool 100. These inputs may be used for calculations in later screens. The business units which correlate to the structure in which a company may organize and operate its business may be input in business unit fields 510. Common company terms include business unit, business segment or division. At employee field 520, the employees per business unit may be entered, such as in terms of full-time equivalents (FTE). In total employee field 530, a total number of employees may be entered, such as in terms of full-time equivalents. A total number may default to the number of employees entered per business unit. The Add Business Unit and Remove Business Unit buttons 540 may be used to add or remove rows for entering the business unit names and number of employees per business unit displayed in field 550.

The screen 500 may also display benchmark data including data from a provider such as SARATOGA, a PricewaterhouseCoopers offering. Other providers may be used. The benchmark data may represent data for a ratio of human resource full-time employees to total employees. The field option may include a quartile field 560 so that the user can select between top quartile, median and lower quartile benchmarks, depending on how the business views itself compared to other businesses. The default target ratio field 570 shows a target ratio for a determined total number of employees and a selected quartile. An override value field 580 may be used if the user has identified a target ratio that differs from the SARAGOTA benchmark. The user may input the override target value. The default target ratio and override values may not control any calculation used in the following worksheets. The values may be used for the comparison of the final estimates to the benchmark.

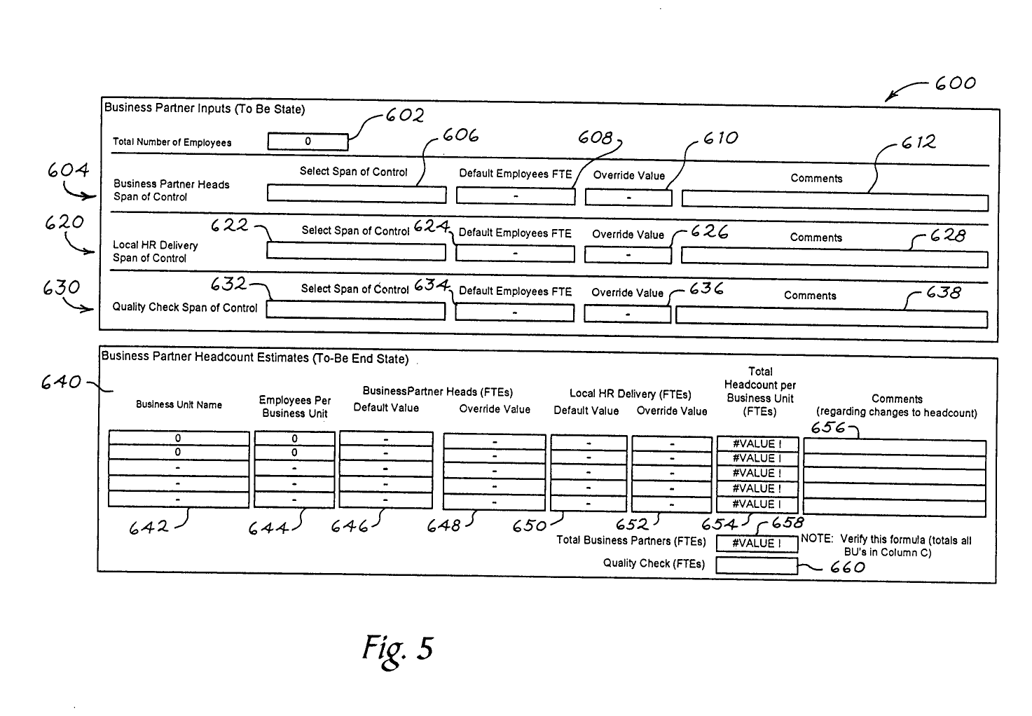

FIG. 5 is a screenshot of an exemplary business partner headcount worksheet 600. A business partner headcount includes business partner heads and local human resource delivery headcounts. A business partner head may represent the human resource headcount that reside within the business units and work with business units to translate business needs into human resource requirements. The local human resource delivery may represent the human resource headcount that resides within the business units and handle one-site, high-touch delivery requirements, e.g., regulatory and local business requirements. The business partner headcount may be based on a few input fields and then calculated based on metrics.

At 602, the total number of employees is entered, such as the number that was entered at the input screen worksheet 500. At 604, the business partner heads span of control may be identified. At 606, the user may select the span of control, such as high, medium or low. A drop down menu and/or pop-up window may be utilized such that when a cursor is placed over a selected area of a field at 606, the user's choices are displayed.

The span of control may allow the user to make quicker decisions than without it such that the process of determining estimated full-time employees may be expedited. For a small company, the low option may be selected. The span of control pop-up or drop down may display the low option as being related to multiple business units, with a highly dispersed organization with multiple languages. The medium option may equate to multiple business units, with employees in several location with a single language. The high option may equate to a single business unit with employees in a few locations and a single language throughout the business unit. The tool 100 displays these descriptions of the span of control options to the user so that an appropriate option may be chosen. The user may select the option that best meets the end state of the business.

Referring to Table 1, the determined option may correlate to a representation of the number of employees that each business partner head can support. The high choice may correlate to one full-time business partner head per 1250 employees for a business unit. The choice medium may correlate to one full-time business partner head per 950 employees for a business unit. The choice low may correlate to one full-time business partner head per 650 employees for a business unit. The actual number of full-time employees per business unit employees may be implementation dependent and other values may be used.

TABLE 1
Business Partner Heads - Span of Control
(# of Employees per 1 BP Head FTE)

| Label | Employees |
|---|---|
| High = 1 FTE per 1250 employees | 1250 |
| per BU | |
| Medium = 1 FTE per 950 | 950 |
| employees per BU | |
| Low = 1 FTE per 650 employees | 650 |
| per BU | |

At field 608, a default field may automatically display the number of employees per full-time equivalent in accordance with the user's selection in field 606. The override value field 610 may be used by the user to enter a target span of control that is different from the default value determined by the tool 100. The override field 610 may default to the same value in the default field 608 unless changed by the user. The override value may be used to calculate the estimated full-time equivalents. At comment field 612, a user comment may be added, such as a reason for the override value being entered.

At line 620, local human resource delivery span of control may be selected to represent the business' end state. At 622, the user may choose a high, medium or low span of control. The selected span of control may be used by the tool 100 to help determine the number of employees that each local human resource delivery full-time employee can support. The span of control low option may be displayed to relate to multiple business units, with a highly dispersed organization with multiple languages, high touch service delivery from business partners/local human resource delivery, minimum human resource process centralization and standardization, and a large unionized workforce. The medium option may equate to multiple business units, with employees in several locations with a single language, a high volume of processes centralized, a high touch service delivery for remaining human resource processes, and a minimum unionized workforce. The high option may equate to a single business unit with employees in a few locations and a single language throughout the business unit, a low touch service delivery, significant human resource process centralization and standardization, and no unionized workforce.

Referring to Table 2, the high option may correlate to one full-time local human resource delivery employee per 700 employees; medium may correlate to one full-time local human resource delivery employee per 550 employees; and low may correlate to one full-time local human resource delivery employee per 400 employees. The value may be automatically entered at field 624 after the user selects the option. At field 626 the user may enter an override value, and a comment may be entered at field 628.

TABLE 2
Local HR Delivery - Span of Control
(# of Employees per 1 Local HR Delivery FTE)

| Label | Employees |
|---|---|
| High = 1 FTE per 700 employees | 700 |
| per BU | |
| Medium = 1 FTE per 550 | 550 |
| employees per BU | |
| Low = 1 FTE per 400 employees | 400 |
| per BU | |

In line 630, quality checking may be performed. The quality check may indicate a number of employees that each business partner head or local human resource delivery full-time employee can support. The span of control may display the low option as a high touch service delivery from business partners/local human resource delivery, minimum human resource process centralization and standardization, a highly dispersed organization, no use of self-service technologies and a large unionized workforce. The medium option may relate to a high volume of processes centralized, a high touch service delivery for remaining human resource processes, employees in several locations, minimal use of self-service technologies and a minimum unionized workforce. The high option may equate to a low touch service delivery, significant human resource process centralization and standardization, employees in a few locations, the use of self-service technologies and no unionized workforce.

In table 3, the quality check high option may correlate to one business partner full-time employee per 450 employees; the medium option may correlate to one business partner full-time employee per 350 employees; and the low option may correlate to one business partner full-time employee per 250 employees. A value may be automatically entered at field 634 after the user chooses the option. At field 636 an override value may be entered. A comment may be entered at field 638. Such quality checking may also be performed for some of the other human resource groups 200, such as for business partners 210.

TABLE 3
Quality Check - Span of Control
(# of Employees per 1 Business Partner FTE)

| Label | Employees |
|---|---|
| High = 1 FTE per 450 employees | 450 |
| Medium = 1 FTE per 350 | 350 |
| employees | |
| Low = 1 FTE per 250 employees | 250 |

The fields at 640 may be used to summarize the determined values per business unit name. Field 642 may indicate the business unit name which may default from the input screen worksheet 500. Field 644 may indicate the number of employees per business unit which may default from the input screen worksheet 500. Field 646 may indicate the calculated values and field 648 may indicate the override values for the business partner heads. Field 646 may be calculated by dividing the employees per business unit field 644 by the business partner head span of control override field 610. Field 650 may indicate the calculated values and field 652 may indicate the override values for local human resource delivery. Field 650 may be calculated by dividing the employees per business unit field 644 by the local HR delivery span of control override field 626. Field 654 may indicate the total estimated headcount per business unit by adding field 648 and 652, Field 656 may list the comments, such as regarding user reasons for changes to headcounts. Field 658 may indicate the total business partners of all the business units by adding all values in field 654. Field 660 may indicate the total aggregate quality check. Field 660 may be calculated by dividing the total number of employees field 602 by the quality check span of control override field 636,

If the difference between the total business partners and the quality check is greater than about one full-time employee, then further analysis may be needed to better determine an appropriate headcount. The needs of the business partner head and the needs of local human resource delivery for each business unit may be considered. The override value fields may be used to adjust the headcount as needed. The recommended headcount may be a value between the calculated total business partners headcount and the quality check values.

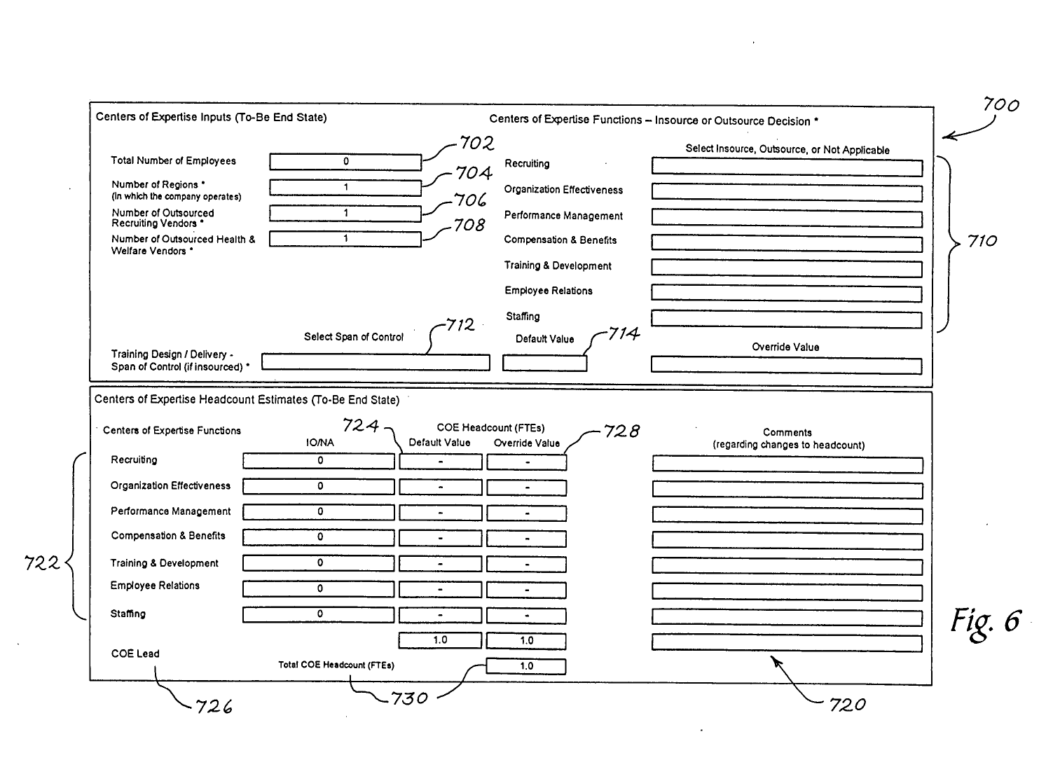

FIG. 6 is a screenshot of an exemplary worksheet 700 for estimating headcount for centers of expertise. Estimates may be organized around the human resource function found in Centers of Expertise, e.g., recruitment, organization effectiveness, performance management, compensation and benefits, training and development, employee relations, and staffing. The estimates may be based on inputs and then calculated based on metrics.

Regarding inputs, at field 702, the user may enter a total number of employees. At field 704, the number of regions in which the company operates may be entered. The number may be equivalent to geographic groupings, e.g., North America, Latin America, Europe, etc. A value of at least one should be entered. Several of the centers of expertise headcounts needs may be based on the headcount needed per region. At field 706, the user may input number of outsourced recruiting vendors. This number may represent recruiting vendors that support either business process outsourcing (BPO) or application outsourcing. The value may impact the full-time equivalents needed for recruiting vendor management, as discussed below. Vendor management included the selection, management and evaluation of third parties, such as recruitment agencies and free lance trainers. At field 708, the number of health and welfare vendors may be entered. This may represent health and welfare vendors that support either BPO or application outsourcing. This value may impact the full-time equivalents needed for heath and welfare vendor management, as discussed below.

At fields 710, the user may select from insourcing, outsourcing or not applicable for each centers of expertise. The centers of expertise may be sub-divided by function 722, such as recruiting, organization effectiveness, performance management, compensation/benefits, training/development, employee relations and staffing. The structure of these functions into centers of expertise may vary significantly across companies. Clients may choose to have a center of expertise corresponding to each function. However, companies may structure these function in other ways such as into logical groupings of centers of expertise, e.g., reward, talent, management, and learning. The selected value may represent the users' decision to insource or outsource the center of expertise function in the to-be end state model. Selection of insourcing or outsourcing the resources may affect the default values for the centers of expertise functions, as described below.

At field 712, the span of control for training design/delivery may be selected by the user. As with business partners, the user may view the selection, such as by placing a cursor over a designated area of the field. The area may be designated with a marker, such as a red triangle. When the red triangle is clicked, definitions for high, medium and low options may be displayed. The user may choose the definition that best fits the client's to-be end state. The high option may relate to minimal classroom training, use of online training, the use of external vendors for training delivery, and a low number of training hours per person. The medium option may relate to a mix of classroom and online training, a use of external vendors and internal resources for training delivery, and a medium number of hours of training per person. The low option may relate to extensive classroom training, a minimal use of online training, a use of internal choices for training delivery, and a high number of hours of training per person. At field 714, use of an override value may be entered by a user to target a span of control that differs from the default value. Table 4 lists exemplary default values for the span of control options.

TABLE 4
Insourced - Training Design/Delivery - Span of Control
(# of Employees per 1 Training FTE)

| Label | Employees |
|---|---|
| High = 1 FTE per 5000 employees | 5000 |
| Medium = 1 FTE per 3000 | 3000 |
| employees | |
| Low = 1 FTE per 700 employees | 700 |

Sheet 720 may calculate outputs for the centers of expertise headcount estimates. The vendor management full-time equivalents may be incorporated into several center of expertise functions rather than having a separate category for vendor management since the full-time equivalents needed for this role may vary by function. Some user's may choose to highlight the vendor management role as a separate center of expertise function, there the worksheet may change to add vendor management or another function. Also, zero full-time equivalents may be entered if the function is not used by the business.

The value in field 724 may automatically calculate based on inputs entered in worksheet 700 and insourced/outsourced assumptions identified in field 724. The assumptions entered in field 724 may differ for each HR function. Regarding recruiting outsourcing, headcount may be calculated using one full-time equivalent per three recruiting vendors for vendor management. Regarding recruiting insourcing, headcount may be calculated using the following accumulated assumptions: one full-time equivalent per region for sourcing, one full-time equivalent for employment brand, one full-time equivalent for policy design, two full-time equivalents for program design, and one full-time equivalent per five recruiting vendors for vendor management. These insourced assumptions may be added together to determine total headcount for recruiting. Regarding organization effectiveness outsourcing, headcount may be calculated using one full-time equivalent per vendor management. Regarding organization effectiveness insourcing, headcount may be calculated using two full-time equivalents per region per change management/organization assessment and three full-time equivalents for job design/workforce modeling. For performance management, outsourcing headcount may be calculated using one full-time equivalent for vendor management, or insourcing headcount may be calculated using one full-time equivalent for performance management and one full-time equivalent for reward recognition.

Regarding compensation/benefits outsourcing, headcount may be calculated by adding the following assumptions: one full-time equivalent for total compensation, one full-time equivalent for retirement, one full-time equivalent for compensation, and one full-time equivalent per five health and welfare vendors for vendor management. Regarding compensation/benefits insourcing, headcount may be calculated using the following assumptions: one full-time equivalent for total compensation, one full-time equivalent for overall compensation, one full-time equivalent for overall benefits, one full-time equivalent for retirement, one full-time equivalent for health and welfare, one full-time equivalent per region for benefits, one full-time equivalent per region for compensation, and one full-time equivalent per seven health and welfare vendors for vendor management.

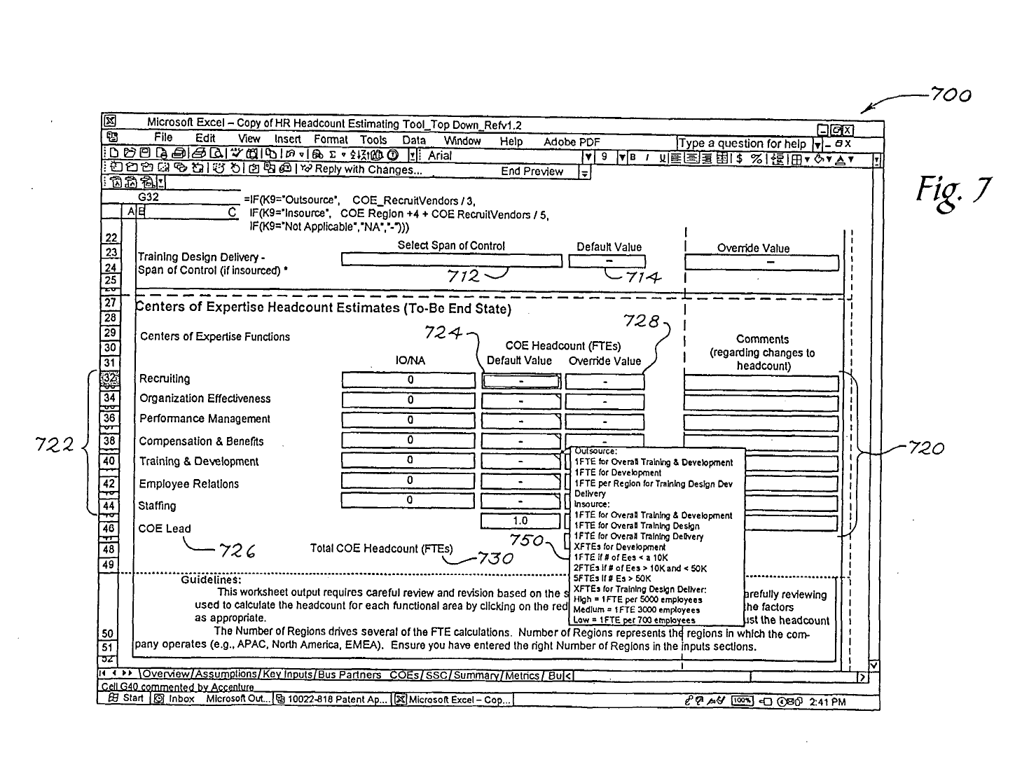

FIG. 7 is a screenshot of centers of expertise headcount estimate with the pop-up choices 750 for default values for estimating training and development headcount. Regarding training and development outsourcing, headcount may be calculated by adding the following assumptions: one full-time equivalent for overall training and development, one full-time equivalent for development, and one full-time equivalent per region for training design/development delivery. Regarding training and development insourcing, headcount may be calculated by adding the following assumptions: one full-time equivalent for overall training and development, one full-time equivalent for overall training design, and one full-time equivalent for overall training delivery. Also for insourcing, add X full-time equivalents for development, such that: one full-time equivalent if a number of employees is less than or equal to ten thousand; two full-time equivalents if the number of employees is greater than ten thousand and less than or equal to fifty thousand; and five full-time equivalents if the number of employees is greater than or equal to fifty thousand. Also for insourcing, add X full-time equivalents for training design/delivery, such that: high equals one full-time equivalent per every five thousand employees; medium equals one full-time equivalent per every three thousand employees; and low equals one full-time equivalent per every seven hundred employees.

Referring again to FIG. 6, for employee relations outsourcing, headcount may be calculated by adding the following assumptions: one full-time equivalent for overall compliance and reporting, one full-time equivalent per region for compliance and reporting, one full-time equivalent for overall labor, and two full-time equivalents per region for labor. Also for outsourcing, add X full-time equivalents for employee satisfaction, such that: one full-time equivalent if the number of employees is less than ten thousand, two full-time equivalents if the number of employees is greater than ten thousand and less than fifty thousand and three full-time equivalents if the number of employees is greater than or equal to fifty thousand employees. Regarding employee relations insourcing, headcount may be calculated by adding the following assumptions: one full-time equivalent for overall compliance and reporting, two full-time equivalents per region for compliance and reporting, one full-time equivalent for overall labor and two full-time equivalents per region for labor. Also for insourcing, add X full-time equivalents for employee satisfaction, such that: one full-time equivalent if a number of employees is less than or equal to ten thousand; three full-time equivalents if the number of employees is greater than ten thousand and less than or equal to fifty thousand; and five full-time equivalents if the number of employees is greater than or equal to fifty thousand.

For staffing insourcing and outsourcing, headcount may be calculated by adding the following assumptions: one full-time equivalent for overall people movement, one full-time equivalent for overall workforce planning, and X full-time equivalents for workplace planning, such that: one full-time equivalent if a number of employees is less than or equal to ten thousand; two full-time equivalents if the number of employees is greater than ten thousand and less than or equal to fifty thousand; and three full-time equivalents if the number of employees is greater than or equal to fifty thousand. The tool includes an assumption that people movement services, e.g., expatriate and relocation programs, may be typically outsourced and workforce planning may typically remain insourced. Therefore, headcount may not differentiate between insourced and outsourced variations.

At field 726, the centers of expertise lead may default to one full-time equivalent. Referring to fields 728, the override field may be used for an override value to refine any of the default values based on specific client requirements. At field 730, the total centers of expertise headcount full-time equivalent estimate may be calculated by adding the values in field 728. Field 720 may be used provide comments, such as why a default value was changed.

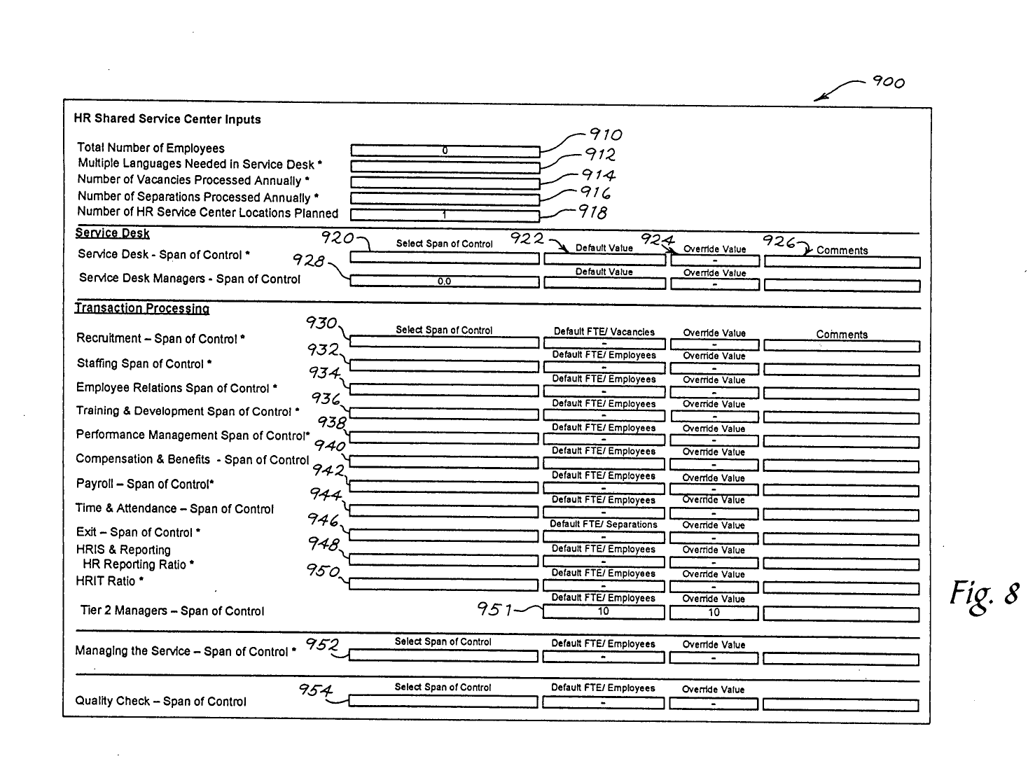

FIG. 8 is a screenshot of a worksheet for exemplary human resource shared service center inputs 900. Estimates may be organized around a service desk (Tier 1) headcount and transaction processing (Tier 2) headcount. The transaction processing headcount may be further organized, or sub-divided, around the HR functions included in HR shared services, e.g., recruitment, staffing, employee relations, training & development, performance management, compensation & benefits, payroll, time & attendance, exit (or separation), HR reporting, and HR information technology. The headcount estimates may be based on a few inputs and then calculated based on the metrics.

A total number of employees, such as the number inputted on another worksheet, may be entered in field 910. The multiple languages needed in service desk field 912 may be inputted from a drop-down or pop-up menu. The choices include: ‘Yes (>=50%)’ if multiple language skill are needed in the service desk, 50% or more of the call require additional language skills; ‘Yes (<50%) if multiple language skills are needed in the service desk, less than 50% of the calls require additional language skills; and ‘No’ if multiple language skills are not needed in the service desk.

Regarding other inputs, a field 914 may be used to represent a number of vacancies or open positions processed annually. This value may impact the full-time equivalents needed for Tier 2 recruiting processing. At field 916, a number of separations processed annually may be entered. This value may impact the full-time equivalents needed for Tier 2 exit processing. Exit processing includes tasks related to voluntary and involuntary separations. At field 918, a number of physical service center locations planned for to-be end state may be entered. The value may default to one. To provide estimates per service center location when multiple service center locations are planned, e.g., regional centers for a global company, the estimated headcounts may be determined per location. For example, the HR shared service estimates for each location may be run separately or the HR shared service estimates may be run together and then broken out proportionate to the number of employees that are served in each center.

At field 920, a span of control selection may be provided for the service desk. This may represent the number of employees that each service desk, e.g. call center, person can support. The user may select a high, medium, or low value from a drop down list or pop-up box. The option high may equate to extensive access to self-service and high change acceptance. The option medium may equate to access to self-service and a medium change acceptance. The option low may relate to minimal access to self-service and low change acceptance. Table 5 lists exemplary default values for the span of control options. The service desk metrics may assume standard hours of operation, e.g., five days a week with twelve hours a day and assume that eighty percent of calls are answered within sixty seconds. The default value may be automatically entered in field 922 based on the selected span of control option. An override value may be entered by the user in field 924 and a comment, such as about the override value, may be entered in field 926. The default 922, override value 924 and comments 926 operate similarly for all the rows, and therefore a discussion of these is not repeated when describing the other functions.

TABLE 5
Service Desk - Span of Control

| Label | Employees |
|---|---|
| High = 1 FTE per 1500 employees | 1500 |
| Medium = 1 FTE per 1200 employees | 1200 |
| Low = 1 FTE per 1000 employees | 1000 |
| Not Applicable | — |

At field 928, a span of control selection may be provided for service desk managers. This may represent a number of service desk employees that one service desk manager can support. The value may default based on the response to field 912 regarding multiple languages needed in the service desk. Table 6 lists exemplary default values for this span of control.

TABLE 6
Service Desk Managers - Span of Control

| Label | FTEs Served |
|---|---|
| Yes (>=50%) | 12 |
| Yes (<50%) | 12 |
| No | 15 |

Span of control options may also be used for transaction processing. Transaction processing may represent the number of employees that each Tier 2 full-time equivalent can support for the specific process, with the exception of recruitment (vacancies) and exit (separations).

At field 930, a span of control selection may be provided for recruitment. The user may select between high if there is a high process standardization, generic recruit profile, and high use technology (e.g., web-based tools) to support processes; medium if there is a medium process standardization, a mix of recruit types, and medium use of technology to support processes; low if there is a low process standardization, diverse recruit types, and a low use of technology (e.g., no web-based tools) to support processes. The recruiting span of control may need to be adjusted for industry specific requirements. For example in the retail industry, the span of control value may need to increase because turnover may be high and the time needed per recruit may be lower. Table 7 lists exemplary default values for this span of control.

TABLE 7
Recruitment - Span of Control

| Label | Vacancies Processed |
|---|---|
| High = 1 FTE per 120 vacancies processed | 120 |
| Medium = 1 FTE per 90 vacancies processed | 90 |
| Low = 1 FTE per 60 vacancies processed | 60 |
| Not Applicable | — |

At field 932, a span of control selection may be provided for staffing. The user may select between high if there is a stable workforce, little work scheduling, low levels of relocation/redeployment, and no expatriate vendor management; medium if there is a moderate mobility, some work scheduling, moderate level relocation/redeployment, and no expatriate vendor management; low if there is a mobile workforce, project based work assignments, high level of relocation/redeployment, and expatriate vendor management. Table 8 lists exemplary default values for this span of control.

TABLE 8
Staffing - Span of Control

| Label | Employees |
|---|---|
| High = 1 FTE per 5500 employees | 5500 |
| Medium = 1 FTE per 4000 employees | 4000 |
| Low = 1 FTE per 3000 employees | 3000 |
| Not Applicable | — |

At field 934, a span of control selection may be provided for employee relations. The user may select between high if there is a low unionization, and a predominately white collar workforce; medium if there is medium unionization and a mix of white collar and blue collar workforce; low if there a high unionization, and predominately blue collar workforce. Table 9 lists exemplary default values for this span of control.

TABLE 9
Employee Relations - Span of Control

| Label | Employees |
|---|---|
| High = 1 FTE per 4000 employees | 4000 |
| Medium = 1 FTE per 2000 employees | 2000 |
| Low = 1 FTE per 1200 employees | 1200 |
| Not Applicable | — |

At field 936, a span of control selection may be provided for training and development. The user may select between high if there is access to online training schedules/registration, set training guideline/plans, and minimal classroom training use of virtual training; medium if there is some access to online training schedules/registration, set training guidelines/plans, and a fairly equal mix of classroom training and virtual training; low if there is no access to online training schedules/registration, minimal training guidelines/plans, extensive classroom training, and minimal use of virtual training. Table 10 lists exemplary default values for this span of control.

TABLE 10
Training & Development - Span of Control

| Label | Employees |
|---|---|
| High = 1 FTE per 2600 employees | 2600 |
| Medium = 1 FTE per 1200 employees | 1200 |
| Low = 1 FTE per 600 employees | 600 |
| Not Applicable | — |

At field 938, a span of control selection may be provided for performance management. The user may select between high if processes are limited to annual review processes, and no performance case management; medium if processes includes annual review processes, and some performance case/discipline management; low if processes include annual review processes, and proactive performance case/discipline management. Table 11 lists exemplary default values for this span of control.

TABLE 11
Performance Management - Span of Control

| Label | Employees |
|---|---|
| High = 1 FTE per 8000 employees | 8000 |
| Medium = 1 FTE per 3000 employees | 3000 |
| Low = 1 FTE per 2000 employees | 2000 |
| Not Applicable | — |

At field 940, a span of control selection may be provided for compensation and benefits. The user may select between high if there is a single country, high process standardization, and a large employee base; medium if there is multiple countries, some process standardization, and a medium employee base; low if there is multiple countries, low process standardization and a small employee base. This may assume that benefits administration and pension administration are outsourced. Table 12 lists exemplary default values for this span of control.

TABLE 12
Compensation & Benefits - Span of Control

| Label | Employees |
|---|---|
| High = 1 FTE per 1500 employees | 1500 |
| Medium = 1 FTE per 1250 employees | 1250 |
| Low = 1 FTE per 1000 employees | 1000 |
| Not Applicable | — |

At field 942, a span of control selection may be provided for payroll. The user may select between high if there is low complexity in pay practices, few number of payroll funs, high payroll transaction volume, and primarily salaried workforce; medium if there is medium complexity in pay practices, medium number of payroll runs, medium payroll transaction volume, and a mix of hourly/salaried workforce; low if there is high complexity in pay practices, a large number of payroll runs, a low payroll transaction volume, and a large hourly workforce. This may assume that the payroll function does not include financial activities that are typically part of finance, such as labor distribution, tax reporting and general ledger. Table 13 lists exemplary default values for this span of control.

TABLE 13
Payroll - Span of Control

| Label | Employees |
|---|---|
| High = 1 FTE per 2000 employees | 2000 |
| Medium = 1 FTE per 1250 employees | 1250 |
| Low = 1 FTE per 800 employees | 800 |
| Not Applicable | — |

At field 944, a span of control selection may be provided for time and attendance. The user may select between high if there is use of self-service tools, no data entry, low workforce complexity (e.g. hourly versus salaried), standardized T&A policies; medium if there is use of self-service tools, exception based data entry, medium workforce complexity (e.g. hourly versus salaried), and some standardization with T&A policies; low if there is no use of self-service tools, minimal manual data entry, high workforce complexity (e.g. hourly versus salaried), and no standardization with T&A policies. Table 14 lists exemplary default values for this span of control.

TABLE 14
Time & Attendance - Span of Control

| Label | Employees |
|---|---|
| High = 1 FTE per 8000 employees | 8000 |
| Medium = 1 FTE per 5000 employees | 5000 |
| Low = 1 FTE per 2000 employees | 2000 |
| Not Applicable | — |

At field 946, a span of control selection may be provided for exiting employees. The user may select between high if there is high process standardization and automation; medium if there is medium process standardization and automation; low if there is low process standardization and automation. The exit span of control may need to be adjusted for government clients where the exit process may be more complex or require more steps. Table 15 lists exemplary default values for this span of control.

TABLE 15
Exit - Span of Control

| Label | Separations Processed |
|---|---|
| High = 1 FTE per 1000 separations | 1000 |
| processed | |
| Medium = 1 FTE per 750 separations | 750 |
| processed | |
| Low = 1 FTE per 500 separations processed | 500 |
| Not Applicable | — |

At field 948, a span of control selection may be provided for human resource reporting ratio. The user may select between high if there is standard reports available through self-service, low ad-hoc reports required, and only a few system house employee date (e.g. use of enterprise resource planning (ERP)); medium if there is some standard reports available through self-service, medium ad-hoc reports required, and several systems house employee data; low if there is few standard reports available through self-service, high ad-hoc reports required, and many systems house employee data. Table 16 lists exemplary default values for this span of control.

TABLE 16
HR Reporting - Span of Control

| Label | Employees |
|---|---|
| High = 1 FTE per 10000 employees | 10000 |
| Medium = 1 FTE per 6000 employees | 6000 |
| Low = 1 FTE per 3000 employees | 3000 |
| Not Applicable | — |

At field 950, a span of control selection may be provided for human resource information technology (IT) ratio. The user may select between high if there is high system stability/standardization/integration, single business unit, one ERP, few supporting system and interfaces, and low volume ongoing changes/enhancement; medium if there is medium system stability/standardization/integration, multiple business units, one ERP, several supporting systems and interfaces, and medium volume ongoing changes/enhancements; low if there is low system stability/standardization/integration, multiple business units, several ERPs, several supporting systems and interfaces, and high volume ongoing changes/enhancements. Table 17 lists exemplary default values for this span of control.

TABLE 17
HR IT - Span of Control

| Label | Employees |
|---|---|
| High = 1 FTE per 3200 employees | 3200 |
| Medium = 1 FTE per 2200 employees | 2200 |
| Low = 1 FTE per 1200 employees | 1200 |
| Not Applicable | — |

At Field 951 a default value of 10 may be entered for the Tier 2 manager span of control. This value may represent the number of Tier 2 transaction processing employees that each Tier 2 manager can support.

At field 952, a span of control selection may be provided for managing the service. Managing the service may represent the human resource shared service center headcount needed for responsibilities such as the following: vendor management (for shared service applications), facilities management, service management, service development and deployment, and knowledge management. This span of control may represent the number of Tier 1 and Tier 2 shared service center employees that each managing the service full-time employee can support. The user may select between high if there is a single business unit, employees in few locations, and a single language across the organization; medium if there is multiple business units, employees in several locations, and a single language across the organization; low if there is multiple business units, highly dispersed organization and multiple languages across the organization. Table 18 lists exemplary default values for this span of control.

TABLE 18
Managing the Service - Span of Control

| Label | Employees |
|---|---|
| High = 1 FTE per 50 employees in service | 50 |
| center | |
| Medium = 1 FTE per 40 employees in | 40 |
| service center | |
| Low = 1 FTE per 30 employees in service | 30 |
| center | |
| Not Applicable | — |

At field 954, a span of control selection may be provided for a quality check for the overall HR shared services headcount. This may represent a number of employees that each human resource shared service center full-time equivalent can support. The user may select between high if there is a single business unit, employees in a few location, and a single language across the organization; medium if there is multiple business units, employees in several location, and a single language across the organization; low if there is multiple business units, highly dispersed organization, and multiple languages across the organization. Table 19 lists exemplary default values for this span of control.

TABLE 19
Quality Check - Span of Control

| Label | Employees |
|---|---|
| High = 1 FTE per 250 employees | 250 |
| Medium = 1 FTE per 200 employees | 200 |
| Low = 1 FTE per 150 employees | 150 |
| Not Applicable | — |

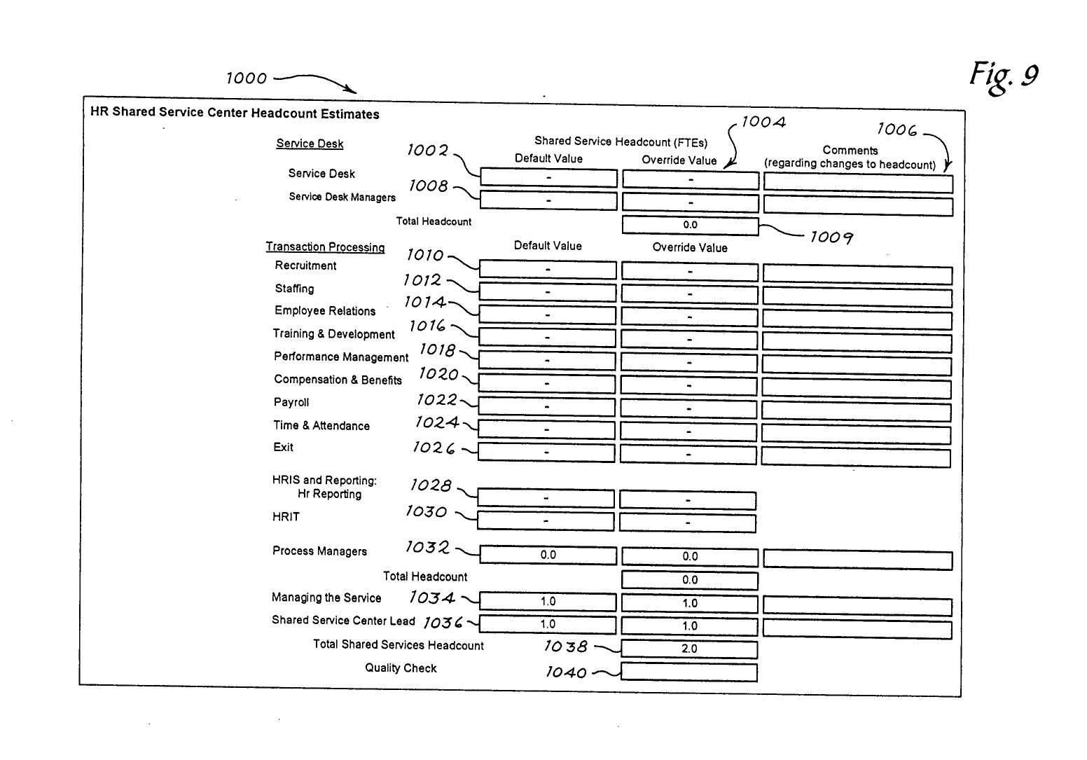

FIG. 9 is a screenshot of outputs 1000 for the human resource shared service center headcount estimates. At field 1002, the default value represents the total Tier 1 service desk full-time equivalents. This value may be automatically calculated by dividing total number of employees field 910 by service desk span of control field 924. This value may also be adjusted based on the multiple languages needed in service desk field 012. If the multiple language entry is greater than or equal to fifty percent, then the headcount estimate is increased by twenty percent. If the multiple language entry is less than fifty percent, then the headcount estimate may be increased by ten percent. If the multiple language entry is no, then the headcount estimate is not adjusted. The override field 1004, for all the rows, may be used to refine the default value based on specific client requirements, and comments can be included in filed 1006. When the service desk estimates are part of a multi-tower shared service solution, they may need to be manually adjusted to account for economies of scale across the shared service structure. These functions may be shared in a multi-tower service delivery model. The override value field 1004 may also be used to decrease headcount where appropriate.

Field 1008 includes a default value representing the total Tier 1 service desk managers. The estimates may be calculated by dividing the number of Tier 1 service desk full-time equivalents field 1004 by the service desk manager span of control. The total headcount field 1009 may display the total Tier 1 headcount.

The values 1010 though 1030 may be calculated based on the inputs entered in worksheet 900 as described with regard to FIG. 9. For example:
Recruitment field 1010 may be calculated by dividing number of vacancies processed annually field 912 by recruitment span of control
Staffing field 1012 may be calculated by dividing total number of employees field 910 by staffing span of control
Employee relations field 1014 may be calculated by dividing total number of employees field 910 by employee relations span of control
Training & development field 1016 may be calculated by dividing total number of employees field 910 by training & development span of control
Performance management field 1018 may be calculated by dividing total number of employees field 910 by performance management span of control
Compensation & benefits field 1020 may be calculated by dividing total number of employees field 910 by compensation span of control
Payroll field 1022 may be calculated by dividing total number of employees field 910 by payroll span of control
Time & attendance field 1024 may be calculated by dividing total number of employees field 910 by time & attendance span of control
Exit field 1026 may be calculated by dividing number of separations processed annually field 916 by exit span of control
HR reporting field 1028 may be calculated by dividing total number of employees field 910 by HR reporting span of control
HR information technology field 1030 may be calculated by dividing total number of employees field 910 by HR information span of control

The process managers field 1032, may represent the default value of the total Tier 2 process managers full-time equivalents. The estimates may be calculated by adding the total transaction processing headcount fields 1010 through 1030 and then dividing by the Tier 2 manager span of control.

The managing the service field 1034 may represent a default value of the managing the service headcount full-time equivalents. The estimates may be calculated by adding the total service desk headcount field 1009 and total transaction processing headcount and then dividing by the managing the service span of control. The calculation may also consider the number of planned service center locations. To ensure at least one full-time equivalent per location, the calculation may default to the greater of the two values, e.g., either total managing the service headcount or number of planned service center locations. When managing the service estimates are part of a multi-tower shared service solution, they may be manually adjusted to account for economies of scale across the shared service structure. The functions may be shared in a multi-tower service delivery model. The override value fields may be used to decrease headcount where appropriate.

Regarding the remaining fields, the shared service lead 1036 may default to one. The total shared services headcount field 1038 may be calculated by adding the total service desk headcount, total transaction processing headcount, managing the service headcount, and shared service center lead. The quality check 1040 span of control may be calculated by dividing the total number of employees field 910 by the quality check span of control. The resulting calculation may provide another perspective of total shared service headcount in aggregate rather than a per tier function. The value may assume all human resource functions are in scope If the difference between the total shared serviced headcount and quality check is more than about ten full-time equivalents, then further analysis may be needed to determine an appropriate total headcount. The headcount needs for Tier 1 and each function in Tier 2 may be carefully considered. The override value fields may be used to adjust the headcount as needed. A recommended headcount may be a value between the total shared services headcount and quality check values.

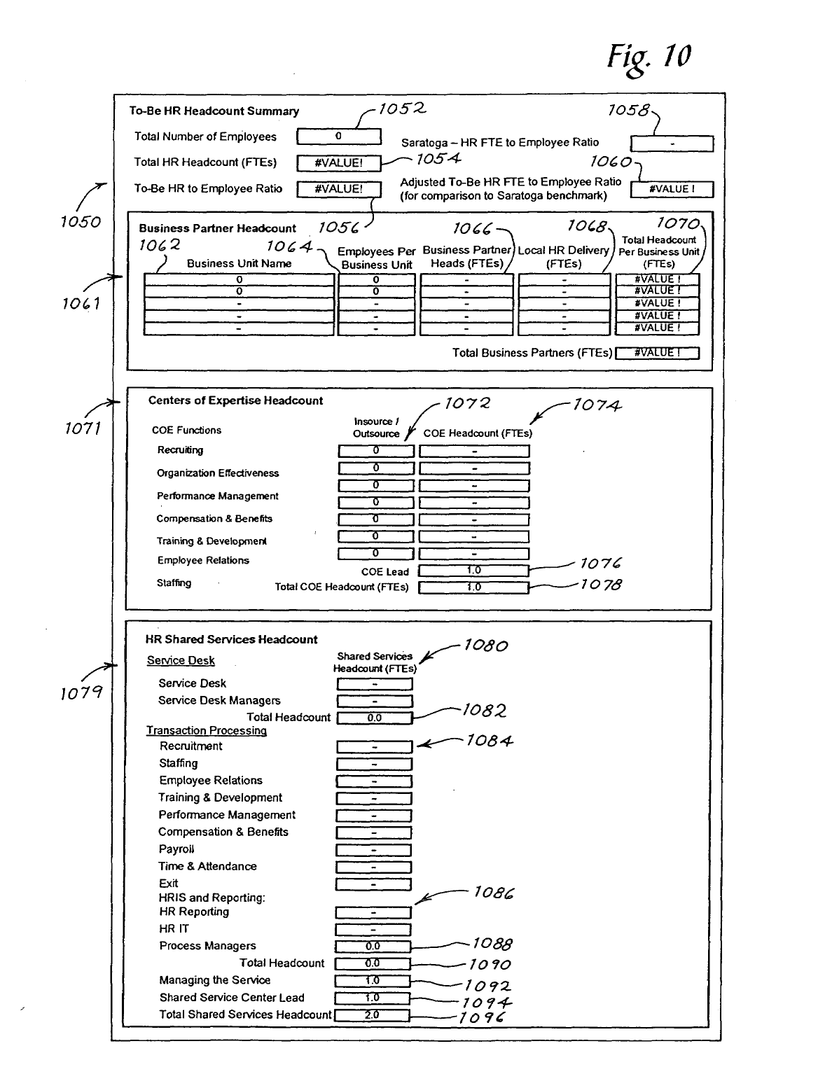

FIG. 10 is a screenshot of an exemplary worksheet 1050 summarizing the headcount calculations from the previous worksheets. The worksheet may bring forward the headcount calculations from the business partner worksheet, the centers of expertise worksheet, and the human resource shared services worksheet. This worksheet calculates the to-be HR to employee ratio and then may compare this ratio to an external benchmark value as an overall check. One source for external benchmark values is SARATOGA, a PricewaterhouseCoopers offering.

FIG. 10 may bring forward values from previous worksheets with minimal calculations in this worksheet. Values in business partner headcount section 1061 may be copied from the values in business partner headcount worksheet 640. Values in centers of expertise section 1071 may be copied from the values in the centers of expertise headcount worksheet 720. Values in human resource shared services headcount section 1079 may be copied from the values in the human resources shared services center headcount worksheet 1000. The total number of employees field 1052 may be copied from the key inputs worksheet field 530. The total human resource headcount field 1054 may be calculated by adding values in worksheet 1050, specifically the total business partners headcount from section 1061, the total centers of expertise headcount field 1078, and the total shared services headcount field 1096. The value for to-be HR headcount to employee ratio field 1056 may be calculated by dividing total number of employees field 1052 by the total human resource headcount field 1054. The target HR full-time equivalent to employee ratio field 1058 may be copied from the key inputs worksheet field 580. The adjusted to-be HR full-time equivalent to employee ratio field 1060 may account for the fact that some human resources functions may not be included in the external benchmark value. For example, SARATOGA, a PricewaterhouseCoopers offering, does not include training and development, payroll and time and attendance in the external benchmark for human resource full-time equivalents to employee ratio. Field 1060 may remove the headcount for these functions from the total human resource headcount value and then recalculate the ratio of human resource full-time equivalents to employees.

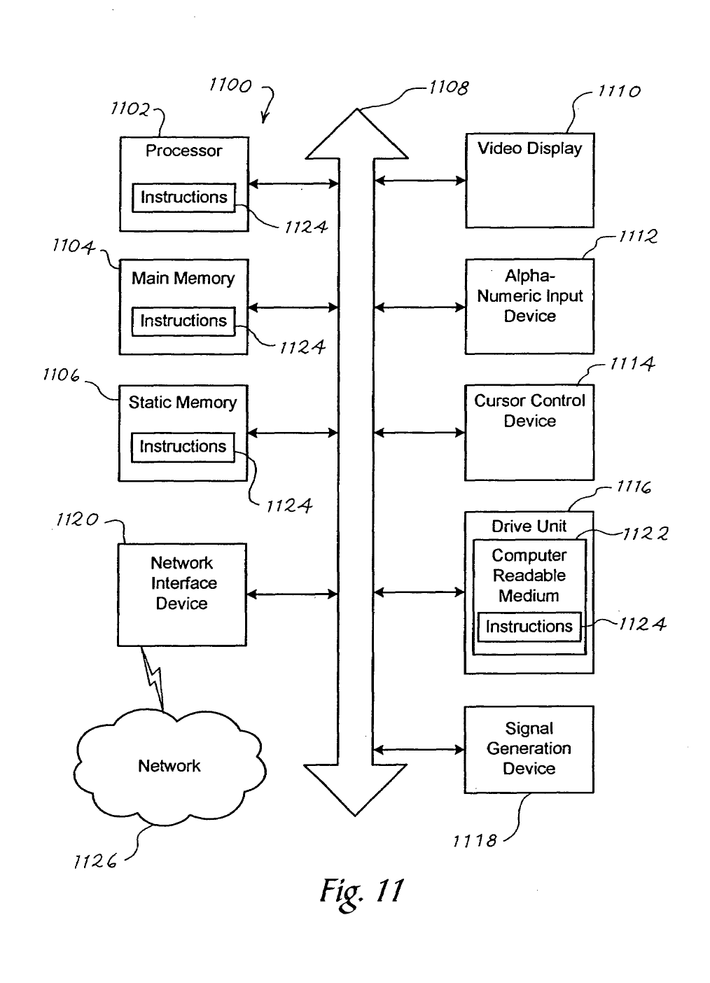

FIG. 11 illustrates a general computer system 1100 that may be used with the tool 100. The computer system 1100 may include a set of instructions that can be executed to cause the computer system 1100 to perform any one or more of the methods or computer based functions disclosed herein. The computer system 1100 may operate as a standalone device or may be connected, e.g., using a network, to other computer systems or peripheral devices. The tool 100 may be implemented hardware, software or firmware, or any combination thereof. Alternative software implementations may be used including, but not limited to, distributed processing or component/object distributed processing, parallel processing, or virtual machine processing may also be constructed to implement the tools described herein.

In a networked deployment, the computer system 1100 may operate in the capacity of a server or as a client user computer in a server-client user network environment, or as a peer computer system in a peer-to-peer (or distributed) network environment. The computer system 1100 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing a set of instructions (sequential or otherwise) that specify actions to be taken by that machine. The computer system 1100 may be implemented using electronic devices that provide voice, video or data communication. Further, while a single computer system 1100 is illustrated, the term “system” shall also be taken to include any collection of systems or sub-systems that individually or jointly execute a set, or multiple sets, of instructions to perform one or more computer functions.

In FIG. 11, the computer system 1100 may include a processor 1102, e.g., a central processing unit (CPU), a graphics processing unit (GPU), or both. Moreover, the computer system 1100 may include a main memory 1104 and a static memory 1106 that may communicate with each other via a bus 1108. The computer system 1100 may further include a video display unit 1110, such as a liquid crystal display (LCD), an organic light emitting diode (OLED), a flat panel display, a solid state display, or a cathode ray tube (CRT). Additionally, the computer system 1100 may include an input device 1112, such as a keyboard, and a cursor control device 1114, such as a mouse. The computer system 1100 may also include a disk drive unit 1116, a signal generation device 1118, such as a speaker or remote control, and a network interface device 1120.

In FIG. 11, the disk drive unit 1116 may include a computer-readable medium 1122 in which one or more sets of instructions 1124, e.g. software, may be embedded. Further, the instructions 1124 may embody one or more of the methods or logic as described herein. In a particular embodiment, the instructions 1124 may reside completely, or at least partially, within the main memory 1104, the static memory 1106, and/or within the processor 1102 during execution by the computer system 1100. The main memory 1104 and the processor 1102 also may include computer-readable media.

Dedicated hardware implementations, such as application specific integrated circuits, programmable logic arrays and other hardware devices, may be constructed to implement one or more of the tools described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit.

The present disclosure contemplates a computer-readable medium that includes instructions 1124 or receives and executes instructions 1124 responsive to a propagated signal so that a device connected to a network 1126 may communicate voice, video or data over the network 1126. Further, the instructions 1124 may be transmitted or received over the network 1126 via the network interface device 1120. While the computer-readable medium is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding or carrying a set of instructions for execution by a processor or that cause a computer system to perform any one or more of the methods or operations disclosed herein.

The computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A method for estimating headcounts, the method comprising:
receiving an input;
receiving a selected a metric, wherein the metric is selected based on a span of control; and
calculating full-time equivalents in accordance with the input and the selected metric.

2. The method of claim 1, wherein the full-time equivalents estimate a business partner headcount.

3. The method of claim 2, further comprising performing a quality check, wherein the quality check comprises comparing the calculated full-time equivalent for the business partner headcount to an overall span of control.

4. The method of claim 1, wherein the full-time equivalents estimate centers of expertise headcount.

5. The method of claim 4, wherein the centers of expertise are sub-divided by function.

6. The method of claim 1, wherein the full-time equivalents estimate a human resource shared service center headcount.

7. The method of claim 6, further comprising performing a quality check, wherein the quality check comprises comparing the calculated full-time equivalent for the shared service center headcount to an overall span of control.

8. The method of claim 6, wherein the human resource shared service center is sub-divided by function.

9. The method of claim 1, wherein the span of control comprises a ranking of high, medium and low.

10. The method of claim 1, further comprising displaying a description, not a value, of the metric.

11. The method of claim 1, wherein the input comprises a number of employees.

12. The method of claim 1, further comprising performing an overall check, wherein the overall check comprises comparing the calculated full-time equivalent to an industry standard.

13. The method of claim 12, further comprising revising the estimates in accordance with the overall check.

14. A system for estimating headcounts, the method comprising:
an input device for receiving an input and a selected a metric, wherein the metric is selected based on a span of control; and
a processor for calculating full-time equivalents in accordance with the input and the selected metric.

15. The system of claim 14, wherein the full-time equivalents estimate a business partner headcount.

16. The method of claim 15, further comprising a quality check, wherein the quality check comprises a comparison of the calculated full-time equivalent for the business partner headcount to an overall span of control.

17. The system of claim 14, wherein the full-time equivalents estimate centers of expertise headcount.

18. The system of claim 17, wherein the centers of expertise estimates are sub-divided by function.

19. The system of claim 14, wherein the full-time equivalents estimate a shared service center headcount.

20. The system of claim 19, further comprising a quality check, wherein the quality check comprises a comparison of the calculated full-time equivalent for the shared service center headcount to an overall span of control.

21. The system of claim 19, wherein the shared service center is sub-divided by function.

22. The system of claim 14, wherein the span of control comprises a ranking of high, medium and low.

23. The system of claim 14, further comprising a display unit for displaying a description, not a value, of the metric.

24. The system of claim 14, wherein the input comprises a number of employees.

25. The system of claim 14, wherein the processor performs an overall check, wherein the overall check comprises comparing the calculated full-time equivalent to an industry benchmark.

26. The system of claim 25, wherein the processor revises the estimates in accordance with the overall check.
